(19) United States
(12) Patent Application Publication
(10) Pub. No.: US 2009/0249048 A1
(43) Pub. Date: Oct. 1, 2009

(54) BRANCH TARGET BUFFER ADDRESSING IN A DATA PROCESSOR

(76) Inventors: Sergio Schuler, Austin, TX (US); Stephen R. Shannon, Austin, TX (US); Michael D. Snyder, Austin, TX (US)

Correspondence Address: FREESCALE SEMICONDUCTOR, INC.;LAW DEPARTMENT, 7700 WEST PARMER LANE MD:TX32/PL02, AUSTIN, TX, 78729, US

(21) Appl. No.: 12/057,543

(22) Filed: Mar. 28, 2008

(51) Int. Cl. G06F 9/32

(52) U.S. Cl. 712/238; 712/E09.075

(57) ABSTRACT

A data processing system includes a branch target buffer (BTB) including a plurality of entries, each entry comprising a tag portion and a long branch indicator. The system also includes segment target address storage circuitry which stores a plurality of segment target addresses, index storage circuitry which stores a plurality of indices for indexing into the segment target address storage circuitry, and control circuitry which receives an instruction address and determines whether the instruction address matches a valid entry in the BTB. When the instruction address matches a valid entry in the BTB and the long branch indicator of the valid entry indicates a long branch, the index storage circuitry provides a selected index of the plurality of indices selected by the received instruction address. In response to the selected index, the segment target address storage circuitry provides a selected segment target address as a higher order target address portion.

### BACKGROUND

1. Field

This disclosure relates generally to data processors, and more specifically, to the execution of branch instructions by data processors.

2. Related Art

Various compression and decompression methods are known to reduce and reconstruct the size or bit length of data processing instructions and data operands such as addresses. The compression methods are implemented for the purpose of reducing the size of communication buses and memory storage required to store such instructions and operands. In one form, a common portion of higher order address bits are stored in a memory at a single storage location and shared with each of a plurality of low order address bits within a range defined for the high order bits. Pipeline stalls can occur when transitioning between differing high order bits.

Other compression methods include the compressing or shortening of software code. When the operands that are being compressed are address values, an available range of address values is significantly reduced. As a result, the ability of a data processing system to operate effectively is typically limited. With shorter address ranges, more operands are required to be retrieved from a main memory rather than a cache and system performance is thereby degraded.

### BRIEF DESCRIPTION OF THE DRAWINGS

The present invention is illustrated by way of example and is not limited by the accompanying figures, in which like references indicate similar elements. Elements in the figures are illustrated for simplicity and clarity and have not necessarily been drawn to scale.

FIG. 1 illustrates in block diagram form a data processing system having a branch target buffer in accordance with one form of the present invention;

FIG. 2 illustrates in block diagram form a portion of a central processing unit (CPU) of the data processing system of FIG. 1 in accordance with one form of the present invention;

FIG. 3 illustrates in block diagram form a portion of the branch target buffer of FIG. 1 in accordance with one form of the present invention; and

FIG. 4 illustrates in flow diagram form one embodiment of an allocation method for use with the branch target buffer of FIG. 1 in accordance with one form of the present invention.

### DETAILED DESCRIPTION

As used herein, the term “bus” is used to refer to a plurality of signals or conductors which may be used to transfer one or more various types of information, such as data, addresses, control, or status. The conductors as discussed herein may be illustrated or described in reference to being a single conductor, a plurality of conductors, unidirectional conductors, or bidirectional conductors. However, different embodiments may vary the implementation of the conductors. For example, separate unidirectional conductors may be used rather than bidirectional conductors and vice versa. Also, a plurality of conductors may be replaced with a single conductor that transfers multiple signals serially or in a time multiplexed manner. Likewise, single conductors carrying multiple signals may be separated out into various different conductors carrying subsets of these signals. Therefore, many options exist for transferring signals.

The terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

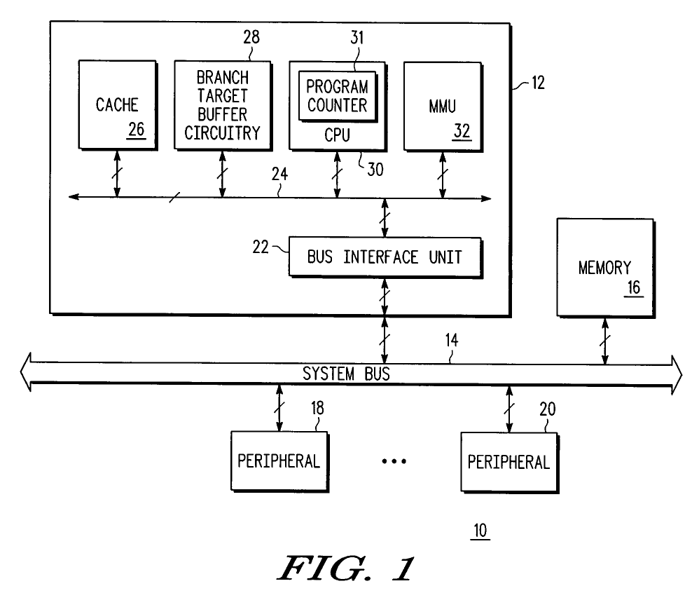

The connectivity and brief operation of FIGS. 1-4 will now be described.

FIG. 1 illustrates, in block diagram form, a data processing system 10 in accordance with one embodiment of the present invention. Data processing system 10 includes a processor 12, a system bus 14, a memory 16 and a plurality of peripherals such as a peripheral 18, a peripheral 20 and, in some embodiments, additional peripherals as indicated by the dots in FIG. 1 separating peripheral 18 from peripheral 20. The memory 16 is a system memory that is coupled to the system bus 14 by a bidirectional conductor that, in one form, has multiple conductors. In the illustrated form each of peripherals 18 and 20 is coupled to the system bus 14 by bidirectional multiple conductors as is the processor 12. The processor 12 includes a bus interface unit 22 that is coupled to the system bus 14 via a bidirectional bus having multiple conductors. The bus interface unit 22 is coupled to an internal bus 24 via bidirectional conductors. In one embodiment, the internal bus 24 is a multiple-conductor communication bus which may be implemented using a bus protocol or which may be implemented using a plurality of signal conductors and/or interconnect circuitry. Coupled to the internal bus 24 via respective bidirectional conductors is a cache 26, branch target buffer (BTB) circuitry 28, a central processing unit (CPU) 30 and a memory management unit (MMU) 32. The CPU 30 is a processor for implementing data processing operations. Within the CPU 30 is a program counter 31 which is a storage device such as a register for holding a count value. Each of cache 26, BTB 28, CPU 30 and MMU 32 are coupled to the internal bus via a respective input/output (I/O) port or terminal.

In operation, the processor 12 functions to implement a variety of data processing functions by executing a plurality of data processing instructions. Cache 26 is a temporary data store for frequently-used information that is needed by the CPU 30. Information needed by the CPU 30 that is not within cache 26 is stored in memory 16. The MMU 32 controls interaction of information between the CPU 30 and the cache 26 and the memory 16. The bus interface unit 22 is only one of several interface units between the processor 12 and the system bus 14. The bus interface unit 22 functions to coordinate the flow of information related to instruction execution including branch instruction execution by the CPU 30. Control information and data resulting from the execution of a branch instruction are exchanged between the CPU 30 and the system bus 14 via the bus interface unit 22. The BTB 28 is a buffer for storing a plurality of entries. Each of the entries corresponds to a fetch group of branch target addresses associated with branch instructions that are executed by the CPU 30. Alternatively, each of the entries corresponds to a branch target address associated with branch instructions that are executed by the CPU 30. Therefore, CPU 30 selectively generates fetch group addresses or a number of individual fetch addresses which are sent via the internal bus 24 to the BTB 28. The BTB 28 contains a subset of all of the possible fetch group or individual fetch addresses that may be generated by CPU 30. In response to receiving a fetch group address or individual fetch addresses from CPU 30, the BTB 28 provides a branch target address to the CPU 30 that corresponds to a branch instruction within a plurality of instructions. The branch target address which the BTB 28 provides is both a valid address and may be predicted to be taken as will be described below.

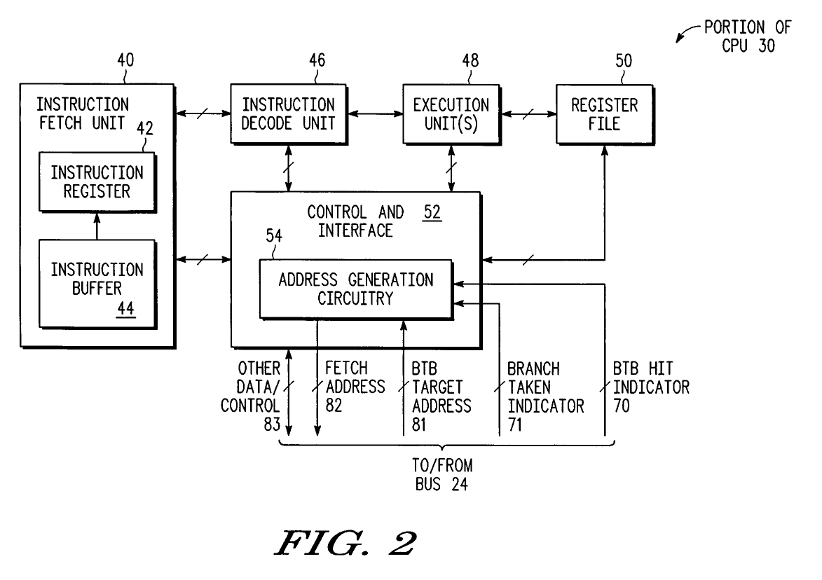

Illustrated in FIG. 2 is one embodiment of a detailed portion of the CPU 30 of FIG. 1 that relates to the execution of instructions and the use of the branch target buffer 28. Alternate embodiments may implement CPU 30 in a different manner. In the illustrated embodiment, an instruction fetch unit 40 is illustrated as including both an instruction buffer 44 and an instruction register 42. The instruction buffer 44 has an output that is connected to an input of the instruction register 42. A multiple conductor bidirectional bus couples a first output of the instruction fetch unit 40 to an input of an instruction decode unit 46 for decoding fetched instructions. An output of the instruction decode unit 46 is coupled via a multiple conductor bidirectional bus to one or more execution unit(s) 48. The one or more execution unit(s) 48 is coupled to a register file 50 via a multiple conductor bidirectional bus. Additionally, each of the instruction fetch unit 40, the instruction decode unit 46, the one or more execution unit(s) 48 and the register file 50 is coupled via separate bidirectional buses to respective input/output terminals of a control and interface unit 52 that interfaces to and from the internal bus 24. The control and interface unit 52 has address generation circuitry 54 having a first input for receiving a BTB Hit Indicator signal 70 and a second input for receiving a Branch Taken Indicator signal 71 via a multiple conductor bus from the branch target buffer circuitry 28 via the internal bus 24. The address generation circuitry 54 also has a second input for receiving a BTB Target Address 81 via a multiple conductor bus from the branch target buffer circuitry 28 via the internal bus 24. The address generation circuitry 54 has a multiple conductor output for providing a Fetch Address signal 82 to the branch target buffer 28 via the internal bus 24. Other data and control signals 83 are communicated via multiple conductors between the control and interface unit 52 and the internal bus 24 for implementing data processing instruction execution.

In the illustrated form of this portion of CPU 30, the control and interface unit 52 controls the instruction fetch unit 40 to selectively identify and implement the fetching of instructions including the fetching of groups of instructions. The instruction decode unit 46 performs instruction decoding for the one or more execution unit(s) 48. The register file 50 is used to support the one or more execution unit(s) 48. Within the control and interface unit 52 is address generation circuitry 54. The address generation circuitry 54 sends out a fetch address 82 to the BTB 28 to obtain branch predictions for multiple instructions. In response to the fetch address 82, a BTB target address 81 is provided to the CPU 30 to identify an address of a group of instructions. The BTB target address 81 is used by CPU 30 to obtain an operand at the target address from either cache 26 or from memory 16 if the address is not present and valid within cache 26.

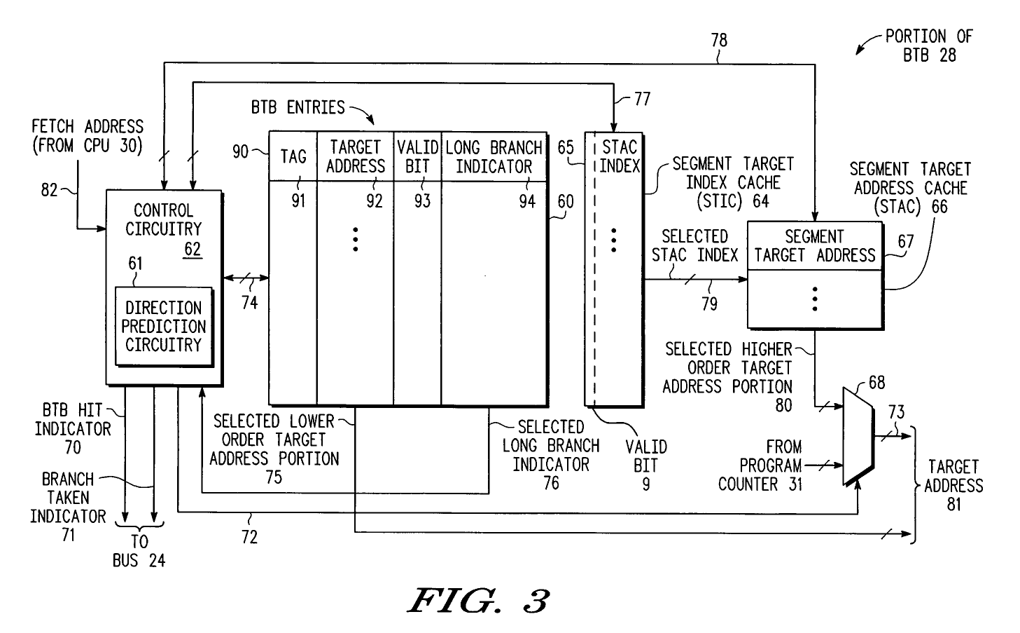

Illustrated in FIG. 3 is further detail of one embodiment of a portion of the BTB circuitry 28 of FIG. 1. Alternate embodiments may implement BTB circuitry 28 in a different manner. In the illustrated embodiment, storage circuitry 60 stores a plurality of BTB entries. In one embodiment, storage circuitry 60 may be implemented using a memory structure, such as, for example, a set associative memory. In the illustrated embodiment, BTB 60 has an input/output terminal coupled to an input/output terminal of control circuitry 62 via a bidirectional multiple conductor bus 74. The control circuitry 62 also has an input for receiving the Fetch Address 82 from the CPU 30. A first output of the control circuitry 62 provides the BTB Hit Indicator signal 70 to the CPU 30 via the bus 24. A second output of the control circuitry 62 provides the Branch Taken Indicator signal 71 to the CPU 30 via the bus 24. Control circuitry 62 is bi-directionally coupled to segment target index cache (STIC) 64 by way of a plurality of conductors 77 for transferring status and control information. Also, control circuitry 62 is bi-directionally coupled to segment target address cache (STAC) 66 by way of a plurality of conductors 78 for transferring status and control information. Control circuitry 62 receives a Selected Long Branch Indicator signal 76 from the long branch indicator portion 94 of BTB entry storage circuitry 60. Control circuitry 62 provides one or more control signals 72 to select circuitry 68. In one embodiment, select circuitry 68 comprises a multiplexer. In alternate embodiments, select circuitry 68 may perform a selecting function in a different manner and/or using different circuitry. In the illustrated embodiments, control circuitry 62 comprises direction prediction circuitry 61.

In the illustrated embodiment, storage circuitry 60 stores a plurality of BTB entries. In one embodiment, each BTB entry 90 comprises a tag portion 91, a target address portion 92, a valid bit 93, and a long branch indicator 94. In the illustrated embodiment, the target address portion 92 of storage circuitry 60 provides a selected lower order target address portion 75 to form a portion of target address 81. In the illustrated embodiment, STIC 64 comprises storage circuitry for storing a plurality of STAC index entries 65, one of which is provided to segment target address cache (STAC) 66 as the selected STAC index 79. In the illustrated embodiment, STAC 66 comprises storage circuitry for storing a plurality of segment target addresses 67, one of which is provided to select circuitry 68 as the selected higher order target address portion 80. Select circuitry 68 receives the selected higher order target address portion 80 from STAC 66 as an input and receives the higher order bits of the instruction address from program counter 31. In one embodiment, control circuitry 62 uses the selected long branch indicator signal 76 from the selected BTB 60 entry to select whether the selected higher order target address portion 80 from STAC 66 or the higher order bits of the instruction address are provided as the higher order bits 73 of the target address 81.

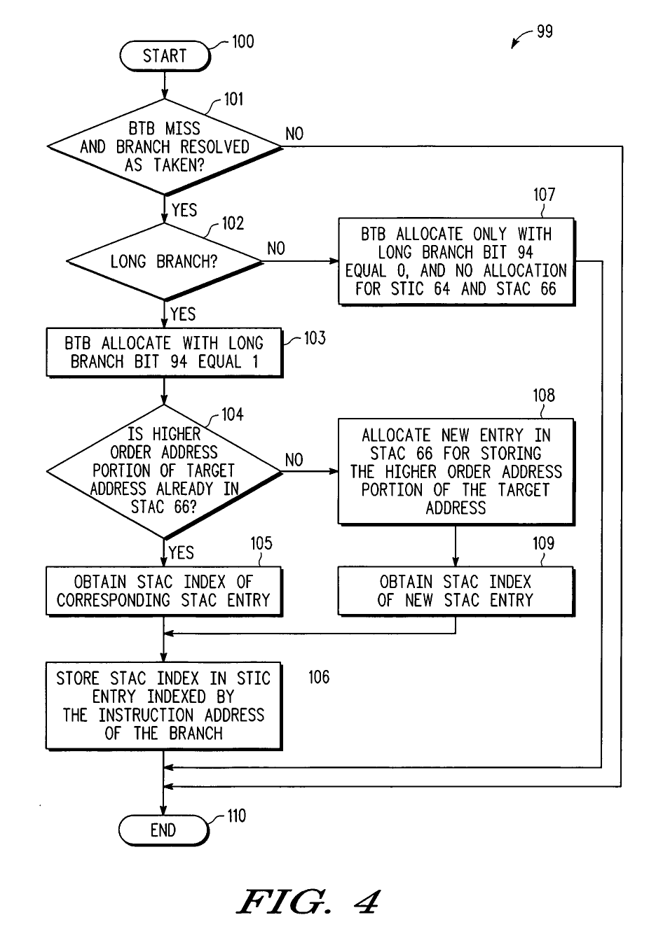

FIG. 4 illustrates in flow diagram form one embodiment of an allocation method for use with the branch target buffer of FIG. 1. Alternate embodiments may implement an allocation method in a different manner. In the illustrated embodiment, flow 99 starts at start oval 100 and proceeds to decision diamond 101 where the question is asked “BTB miss and branch resolved as taken?”. If the answer is no, flow 99 continues to end oval 110 where the flow 99 ends. If the answer at decision diamond 101 is yes, flow 99 continues to decision diamond 102 where the question is asked “long branch?”. If the answer is no (i.e. the branch is not a long branch), flow 99 continues to block 107 where a BTB entry 90 is allocated with its long branch indicator bit 94 equal to zero, and no entry in the STIC 64 is allocated and no entry in the STAC 66 is allocated. From block 107, flow 99 continues to end oval 110 where the flow 99 ends.

If the answer at decision diamond 102 is yes, flow 99 continues to block 103 where a BTB entry 90 is allocated with its long branch indicator bit 94 equal to one. From block 103, flow 99 continues to decision diamond 104 where the question is asked “is the higher address portion of the target address already in STAC 66?”. If the answer is no, flow 99 continues to block 108 where a new entry 67 (segment target address) is allocated in STAC 66 for storing the higher order address portion of the target address. From block 108, flow 99 continues to block 109 where the STAC index 65 is obtained for the new entry 67 in STAC 66. From block 109, flow 99 continues to block 106. If the answer at decision diamond 104 is yes, flow 99 continues to block 105 where the STAC index 65 is obtained for the existing corresponding entry 67 in STAC 66. Note that the selected STAC index 79 is used to point to a corresponding one of the segment target addresses 67 stored in STAC 66. From block 105 and block 109, flow 99 continues to block 106 where the new STAC index 65 is stored in STIC 64 at the entry 65 indexed or pointed to by the instruction address of the branch. Alternatively, at block 106, the new STAC index 65 is stored in STIC 64 at the entry 65 indexed or pointed to by the fetch group address containing the instruction address of the branch. From block 106, flow 99 continues to end oval 110 where the flow 99 ends.

The operation of FIGS. 1-4 will now be described in more detail.

Referring to FIG. 3, in operation, a Fetch Address 82 is received from the CPU 30. In the illustrated embodiment, the direction prediction circuitry 61 uses the Fetch Address 82 to determine if the branch is predicted taken. If the branch is predicted taken, the Branch Taken Indicator signal 71 is asserted. If the branch is not predicted taken, the Branch Taken Indicator 71 is not asserted. Control circuitry 62 uses one instruction address from the Fetch Address 82, and by comparing the instruction address to the tag 91, determines whether an entry corresponding to the instruction address exists in the BTB storage circuitry 60. If so, the BTB Hit Indicator signal 70 is asserted. If not, the BTB Hit Indicator 70 is not asserted, and the CPU 30 determines that the branch has not been taken and fetch continues with the next sequential address.

If the Branch Taken Indicator signal 71 is asserted and the BTB Hit Indicator signal 70 is asserted, the branch is predicted taken and the BTB control circuitry 62 retrieves the requested BTB Target Address 92 from the correct entry in storage circuitry 60 and outputs that address as the selected lower order target address portion 75 to the CPU 30. Note that in the illustrated embodiment, the BTB Target Address 92 contains the lower order target address bits and must be joined with the higher order target address bits in order to form the target address 81, which may then be provided to CPU 30. In order to provide the higher order target address bits, two levels of indexing are used to reduce the amount of storage circuitry required. For many embodiments, there may be a large number of branch instructions which branch to a small number of distant memory segments. Thus, a plurality of target addresses 92 may use the same higher order target address bits when forming the target address 81. As a result, storage circuitry 60, 64, and 66 may be very compact and require less circuitry and less semiconductor area than alternate methods for handling branch prediction.

In the illustrated embodiment, the higher order target address bits are retrieved in the following manner. The fetch address 82 is used as an index 77 into the segment target index cache (STIC) 64 to retrieve one STAC index entry 65 as the selected STAC index 79. The selected STAC index 79 is used as an index into the segment target address cache (STAC) 66 to retrieve one segment target address entry 67 as the selected higher order target address portion 80. The selected higher order target address portion 80 is provided to MUX 68 as an input. MUX 68 also receives the higher order bits of the instruction address from program counter 31. In one embodiment, control circuitry 62 uses the selected long branch indicator signal 76 from the selected BTB 60 entry to select whether the selected higher order target address portion 80 from STAC 66 or the higher order bits of the instruction address are provided as the higher order bits of the target address 81. In an alternate embodiment, when multiple banks are used to implement BTB 60 in order to concurrently predict multiple instructions for a given fetch address 82, control circuitry 62 uses the direction prediction circuitry 61 to determine which bank of BTB 60 provides the selected long branch indicator signal 76.

Note that when multiple banks are used to implement BTB 60 in order to concurrently predict multiple instructions for a given fetch address 82, the fetch address 82 corresponds to a plurality of instruction addresses (e.g. four instruction addresses). However, when only one bank is used to implement BTB 60, only one instruction is predicted at a time and the fetch address 82 is the same as the instruction address.

FIG. 4 illustrates one embodiment of the case when BTB 60 misses and a branch is resolved as taken. In one embodiment, if the BTB 60 hits, a branch is resolved as taken, and the higher order address portion is mispredicted, then the STIC 64 and the STAC 66 do not contain the information needed to provide the correct higher order address portion. It is thus necessary to allocate an entry in both the STIC 64 and the STAC 66 to store the new information. Any desired replacement algorithm may be used to determine which entry 67 in STAC 66 is overwritten with the new information. Some examples of a replacement algorithm are pseudo least recently used, round robin, etc. Once the entry 67 to be replaced in STAC 66 is selected and the correct higher order address portion is stored in that entry 67 in STAC 66, then the index to that entry 67 in STAC 66 is written into STIC 64 at the location pointed to by a portion 77 of the fetch address 82. Alternate embodiments may allocate STAC 66 and STIC 64 entries in a different manner. Note that for one embodiment, step 101 describes a situation in which the instruction address did not match any of the tags 91 in BTB 60, and thus a BTB miss occurred. And for one embodiment, step 102 defines a long branch to be a branch for which the higher order bits of the target address 92 are different from the higher order bits of the instruction address. Alternate embodiments may define a long branch in a different manner.

In an alternate embodiment, a miss in BTB 60 for a long branch where the branch is resolved as taken may result in an allocation in the BTB 60, the STIC 64, and the STAC 66. This may result in some entries in BTB 60 and/or STIC 64 being left pointing to an entry 67 in STAC 66 that was changed due to being allocated. In some embodiment, control circuitry 62 may invalidate those long branch entries in BTB 60 and/or STIC 64 that no longer point to a valid entry 67 in STAC 66. Invalidating an entry in BTB 60 may be accomplished by altering the state or value of the valid bit 93. Similarly, each entry 65 in STIC 64 may have a corresponding valid bit 9; and invalidating an entry in STIC 64 may be accomplished by altering the state or value of the valid bit 9 corresponding to the invalid entry 65 in STIC 64. This may result in reducing the probability of mispredictions for long branches. However, other alternate embodiments may not have valid bits 9 in STIC 64 and may not alter valid bits 93 in BTB 60 as a result of an allocation in STAC 66.

By now it should be appreciated that there has been provided a method and apparatus for performing branch target buffer addressing in a data processing system.

Because the apparatus implementing the present invention is, for the most part, composed of electronic components and circuits known to those skilled in the art, circuit details will not be explained in any greater extent than that considered necessary as illustrated above, for the understanding and appreciation of the underlying concepts of the present invention and in order not to obfuscate or distract from the teachings of the present invention.

Some of the above embodiments, as applicable, may be implemented using a variety of different information processing systems. For example, although FIG. 1 and the discussion thereof describe an exemplary information processing architecture, this exemplary architecture is presented merely to provide a useful reference in discussing various aspects of the invention. Of course, the description of the architecture has been simplified for purposes of discussion, and it is just one of many different types of appropriate architectures that may be used in accordance with the invention. Those skilled in the art will recognize that the boundaries between logic blocks are merely illustrative and that alternative embodiments may merge logic blocks or circuit elements or impose an alternate decomposition of functionality upon various logic blocks or circuit elements.

Thus, it is to be understood that the architectures depicted herein are merely exemplary, and that in fact many other architectures can be implemented which achieve the same functionality. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected,” or “operably coupled,” to each other to achieve the desired functionality.

Also for example, in one embodiment, the illustrated elements of system 10 are circuitry located on a single integrated circuit or within a same device. Alternatively, system 10 may include any number of separate integrated circuits or separate devices interconnected with each other. For example, memory 16 may be located on a same integrated circuit as cache 26 and MMU 32 or on a separate integrated circuit or located within another peripheral or slave discretely separate from other elements of system 10. Peripherals 18 and/or 20 and CPU 30 may also be located on separate integrated circuits or devices. Also for example, system 10 or portions thereof may be soft or code representations of physical circuitry or of logical representations convertible into physical circuitry. As such, system 10 may be embodied in a hardware description language of any appropriate type.

Furthermore, those skilled in the art will recognize that boundaries between the functionality of the above described operations are merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

Although the invention is described herein with reference to specific embodiments, various modifications and changes can be made without departing from the scope of the present invention as set forth in the claims below. For example, BTB 60 (see FIG. 3) may be implemented as a set associative memory with multiple ways, may be implemented using multiple banks, or both. In alternate embodiments, STIC 64 may be implemented as part of BTB 60 so that each BTB entry 90 comprises a STAC index. In an alternate embodiment, the lower order target address portion 75 may be provided by other circuitry instead of BTB 60. For example, additional storage circuitry or an additional cache (e.g. a computed target address cache) (not shown) may be used to provide the lower order target address portion. Such additional storage circuitry may be indexed by a combination of a portion of fetch address 82 and a portion of one or more target addresses of recently taken indirect branches. Accordingly, the specification and figures are to be regarded in an illustrative rather than a restrictive sense, and all such modifications are intended to be included within the scope of the present invention. Any benefits, advantages, or solutions to problems that are described herein with regard to specific embodiments are not intended to be construed as a critical, required, or essential feature or element of any or all the claims.

The term “coupled,” as used herein, is not intended to be limited to a direct coupling or a mechanical coupling.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

### Additional Text

1. A data processing system for example (10) comprising:
a branch target buffer for example (BTB) (60) comprising a plurality of entries, each entry for example (90) comprising a tag portion for example (91) and a long branch indicator for example (94);
segment target address storage circuitry for example (STAC 66) which stores a plurality of segment target addresses for example (67);
index storage circuitry for example (STIC 64) which stores a plurality of indices for example (65) for indexing into the segment target address storage circuitry for example (STAC 66); and
control circuitry for example (62) which receives an instruction address for example for example (82) and determines whether the instruction address for example (82) matches a valid entry in the BTB for example (60);
wherein when the instruction address for example (82) matches a valid entry in the BTB for example (60) and the long branch indicator for example (94) of the valid entry indicates a long branch, the index storage circuitry for example (STIC 64) provides a selected index for example (79) of the plurality of indices selected by the received instruction address, and in response to the selected index for example (79), the segment target address storage circuitry for example (STAC 66) provides a selected one of the plurality of segment target addresses for example (67) as a higher order target address portion for example (80).

2. The data processing system of statement 1, wherein each entry for example (90) of the BTB for example (60) further comprises a target address portion for example (92), and wherein, when the instruction address for example (82) matches a valid entry in the BTB and the long branch indicator for example (94) of the valid entry indicates a long branch, the BTB provides the target address portion for example (92) from the matching valid entry as a lower order target address portion for example (75).

3. The data processing system of statement 2, wherein the lower order address portion for example (75) provided by the BTB for example (60) and the higher order address portion for example (80) provided by the segment target address storage circuitry for example (STAC 66) together form a target address for example (81) corresponding to the instruction address for example (82).

4. The data processing system of statement 2, wherein when the long branch indicator for example (94) of the matching valid BTB entry does not indicate a long branch, the BTB for example (60) provides the target address portion from the matching valid entry as the lower order target address portion for example (75) and a portion of the instruction address for example (bottom input to MUX 68 from program counter 31) is provided as the higher order target address portion for example (73).

5. The data processing system of statement 1, wherein the control circuitry for example (62) provides a BTB hit indicator for example (70) which indicates whether the instruction address for example (82) matches a valid entry in the BTB for example (60), wherein when the instruction address matches a valid entry in the BTB, the control circuitry provides a branch taken indicator for example (71) to indicate whether the instruction address corresponds to a predicted taken branch.

6. The data processing system of statement 5, wherein when the BTB hit indicator for example (70) indicates that the instruction address for example (82) matches a valid entry in the BTB and the branch taken indicator for example (71) indicates that the instruction address for example (82) corresponds to a predicted taken branch, the data processing system uses a lower order target address portion for example (75) together with the higher order address portion for example (80) provided by the segment target address storage circuitry for example (STAC 66) as a target address for example (81) to fetch a next instruction.

7. The data processing system of statement 1, wherein the selected index for example (79) of the plurality of indices provided by the index storage circuitry for example (STIC 64) is selected by a higher order portion of the received instruction address for example (82).

8. The data processing system of statement 1, wherein the control circuitry for example (62), in response to a branch instruction which missed in the BTB being resolved as taken for example (yes path from block 101), allocates an entry for example (90) for the branch instruction in the BTB for example (block 107 or 103).

9. The data processing system of statement 8, wherein the control circuitry for example (62), in response to the branch instruction which missed in the BTB for example (60) being resolved as taken and being a long branch for example (yes path from block 102), sets the long branch indicator for example (94) of the allocated entry to a first value for example (“1” in block 103).

10. The data processing system of statement 9, wherein the control circuitry for example (62), in response to the branch instruction which missed in the BTB being resolved as taken and not being a long branch for example (no path from block 102), sets the long branch indicator for example (94) of the allocated entry to a second value for example (“0” in block 107).

11. The data processing system of statement 9, wherein the control circuitry for example (62), in response to the branch instruction which missed in the BTB being resolved as taken and being a long branch for example (yes path from 102), allocates a new entry for example (block 108) in the segment target address storage circuitry for example (STAC 66) for storing a higher order address portion of a target address of the branch instruction if the higher order address portion of the target address is not already stored in the segment target address storage circuitry.

12. In a data processing system for example (10) having a branch target buffer for example (BTB) (60) and segment target address storage circuitry for example (STAC 66) which stores a plurality of segment target addresses, a method comprising:
receiving an instruction address for example (82);
determining if the instruction address for example (82) matches a valid entry in the BTB for example (60); and
when the instruction address for example (82) matches a valid entry in the BTB and the long branch indicator for example (94) of the valid entry for example (90) indicates a long branch, the method further comprises:
   providing a lower order target address portion for example (75);
   providing an index value for example (79); and
   in response to the index value for example (79), providing from the segment target address storage circuitry for example (STAC 66), a selected one of the plurality of segment target addresses for example (67) as a higher order target address portion for example (80).

13. The method of statement 12, wherein providing the lower order target address portion comprises providing the lower order target address portion for example (75) from the matching entry for example (90) in the BTB for example (60).

14. The method of statement 12, wherein the index value for example (79) is a selected one of a plurality of index values for example (65) that is selected by using at least a portion of the instruction address for example (82), wherein each of the plurality of index values indexes into the segment target address storage circuitry for example (STAC 66).

15. The method of statement 12, wherein the index value for example (79) is a selected one of a plurality of index values for example (65) that is selected by using a higher order portion for example (77) of the instruction address for example (82), wherein each of the plurality of index values indexes into the segment target address storage circuitry for example (STAC 66).

16. The method of statement 12, further comprising:
providing the lower order target address portion for example (75) and the higher order target address portion for example (73) together as a target address for example (81); and
fetching a next instruction stored at the target address.

17. The method of statement 12, further comprising:
resolving a branch instruction which missed in the BTB as taken for example (yes path from block 101); and
allocating an entry for the branch instruction in the BTB for example (block 103 or 107), wherein if the branch instruction is a long branch, allocating comprises setting the long branch indicator to indicate a long branch for example (block 103).

18. The method of statement 12, further comprising:
resolving a long branch instruction which missed in the BTB as taken for example (yes path from block 101); and
allocating a new entry in the segment target address storage circuitry for storing a higher order address portion of a target address of the long branch instruction when the higher order address portion of the target address of the long branch instruction is not already present in the segment target address storage circuitry for example (block 108).

19. A data processing system for example (10) comprising:
segment target address storage circuitry for example (STAC 66) which stores a plurality of segment target addresses;
a branch target buffer for example (BTB) (60) comprising a plurality of entries, each entry comprising a tag portion for example (92), a long branch indicator for example (94), and an index for example (65) for indexing into the segment target address storage circuitry for example (for example STAC 66) for example (in some examples there may not be a separate STIC 64, instead it may be part of BTB 60);
control circuitry for example (62) which receives an instruction address for example (82) and determines whether the instruction address matches a valid entry in the BTB for example (90);
wherein when the instruction address for example (82) matches a valid entry in the BTB and the long branch indicator for example (94) of the valid entry indicates a long branch, the BTB provides the index from the matching valid entry as a selected index for example (79), and, in response to the selected index, the segment target address storage circuitry for example (STAC 66) provides a selected one of the plurality of segment target addresses for example (67) as a higher order target address portion for example (80).

20. The data processing system for example (10) of statement 1, wherein each entry of the BTB for example (60) further comprises a target address portion for example (92), and wherein, when the instruction address for example (82) matches a valid entry in the BTB and the long branch indicator for example (94) of the valid entry indicates a long branch, the BTB provides the target address portion for example (92) from the matching valid entry as a lower order target address portion, and wherein the lower order address portion provided by the BTB and the higher order address portion provided by the segment target address storage together form a target address corresponding to the instruction address.

What is claimed is:

1. A data processing system comprising:
a branch target buffer comprising a plurality of entries, each entry comprising a tag portion and a long branch indicator;
segment target address storage circuitry which stores a plurality of segment target addresses;
index storage circuitry which stores a plurality of indices for indexing into the segment target address storage circuitry; and
control circuitry which receives an instruction address and determines whether the instruction address matches a valid entry in the BTB;
wherein when the instruction address matches a valid entry in the BTB and the long branch indicator of the valid entry indicates a long branch, the index storage circuitry provides a selected index of the plurality of indices selected by the received instruction address, and in response to the selected index, the segment target address storage circuitry provides a selected one of the plurality of segment target addresses as a higher order target address portion.

2. The data processing system of claim 1, wherein each entry of the BTB further comprises a target address portion, and wherein, when the instruction address matches a valid entry in the BTB and the long branch indicator of the valid entry indicates a long branch, the BTB provides the target address portion from the matching valid entry as a lower order target address portion.

3. The data processing system of claim 2, wherein the lower order address portion provided by the BTB and the higher order address portion provided by the segment target address storage circuitry together form a target address corresponding to the instruction address.

4. The data processing system of claim 2, wherein when the long branch indicator of the matching valid BTB entry does not indicate a long branch, the BTB provides the target address portion from the matching valid entry as the lower order target address portion and a portion of the instruction address is provided as the higher order target address portion.

5. The data processing system of claim 1, wherein the control circuitry provides a BTB hit indicator which indicates whether the instruction address matches a valid entry in the BTB, wherein when the instruction address matches a valid entry in the BTB, the control circuitry provides a branch taken indicator to indicate whether the instruction address corresponds to a predicted taken branch.

6. The data processing system of claim 5, wherein when the BTB hit indicator indicates that the instruction address matches a valid entry in the BTB and the branch taken indicator indicates that the instruction address corresponds to a predicted taken branch, the data processing system uses a lower order target address portion together with the higher order address portion provided by the segment target address storage circuitry as a target address to fetch a next instruction.

7. The data processing system of claim 1, wherein the selected index of the plurality of indices provided by the index storage circuitry is selected by a higher order portion of the received instruction address.

8. The data processing system of claim 1, wherein the control circuitry, in response to a branch instruction which missed in the BTB being resolved as taken, allocates an entry for the branch instruction in the BTB.

9. The data processing system of claim 8, wherein the control circuitry, in response to the branch instruction which missed in the BTB being resolved as taken and being a long branch, sets the long branch indicator of the allocated entry to a first value.

10. The data processing system of claim 9, wherein the control circuitry, in response to the branch instruction which missed in the BTB being resolved as taken and not being a long branch, sets the long branch indicator of the allocated entry to a second value.

11. The data processing system of claim 9, wherein the control circuitry, in response to the branch instruction which missed in the BTB being resolved as taken and being a long branch, allocates a new entry in the segment target address storage circuitry for storing a higher order address portion of a target address of the branch instruction if the higher order address portion of the target address is not already stored in the segment target address storage circuitry.

12. In a data processing system having a branch target buffer and segment target address storage circuitry which stores a plurality of segment target addresses, a method comprising:
receiving an instruction address;
determining if the instruction address matches a valid entry in the BTB; and
when the instruction address matches a valid entry in the BTB and the long branch indicator of the valid entry indicates a long branch, the method further comprises:
providing a lower order target address portion;
providing an index value; and
in response to the index value, providing from the segment target address storage circuitry, a selected one of the plurality of segment target addresses as a higher order target address portion.

13. The method of claim 12, wherein providing the lower order target address portion comprises providing the lower order target address portion from the matching entry in the BTB.

14. The method of claim 12, wherein the index value is a selected one of a plurality of index values that is selected by using at least a portion of the instruction address, wherein each of the plurality of index values indexes into the segment target address storage circuitry.

15. The method of claim 12, wherein the index value is a selected one of a plurality of index values that is selected by using a higher order portion of the instruction address, wherein each of the plurality of index values indexes into the segment target address storage circuitry.

16. The method of claim 12, further comprising:
providing the lower order target address portion and the higher order target address portion together as a target address; and
fetching a next instruction stored at the target address.

17. The method of claim 12, further comprising:
resolving a branch instruction which missed in the BTB as taken; and
allocating an entry for the branch instruction in the BTB, wherein if the branch instruction is a long branch, allocating comprises setting the long branch indicator to indicate a long branch.

18. The method of claim 12, further comprising:
resolving a long branch instruction which missed in the BTB as taken; and
allocating a new entry in the segment target address storage circuitry for storing a higher order address portion of a target address of the long branch instruction when the higher order address portion of the target address of the long branch instruction is not already present in the segment target address storage circuitry.

19. A data processing system comprising:
segment target address storage circuitry which stores a plurality of segment target addresses;
a branch target buffer comprising a plurality of entries, each entry comprising a tag portion, a long branch indicator, and an index for indexing into the segment target address storage circuitry;
control circuitry which receives an instruction address and determines whether the instruction address matches a valid entry in the BTB;
wherein when the instruction address matches a valid entry in the BTB and the long branch indicator of the valid entry indicates a long branch, the BTB provides the index from the matching valid entry as a selected index, and, in response to the selected index, the segment target address storage circuitry provides a selected one of the plurality of segment target addresses as a higher order target address portion.

20. The data processing system of claim 1, wherein each entry of the BTB further comprises a target address portion, and wherein, when the instruction address matches a valid entry in the BTB and the long branch indicator of the valid entry indicates a long branch, the BTB provides the target address portion from the matching valid entry as a lower order target address portion, and wherein the lower order address portion provided by the BTB and the higher order address portion provided by the segment target address storage together form a target address corresponding to the instruction address.
